(19) United States
(12) Patent Application Publication
(10) Pub. No.: US 2025/0102340 A1
(43) Pub. Date: Mar. 27, 2025

(54) MULTIPHASE FLOW CHARACTERISTICS MEASUREMENT SYSTEM, DEMODULATION METHOD FOR A MULTIPHASE FLOW CHARACTERISTICS MEASUREMENT SYSTEM AND ELECTRONIC CIRCUIT

(71) Applicants: UNIVERSIDADE ESTADUAL DE CAMPINAS, Campinas (BR); PETRÓLEO BRASILEIRO S.A. - PETROBRAS, Rio de Janeiro (BR)

(72) Inventors: Daniely Amorim Das Neves, Brasília (BR); Saon Crispim Vieira, Santos (BR); Juliana Rangel Cenzi, Jacareí (BR); Bruna Rodrigues Barbosa, Campinas (BR); Bernardo Pereira Foresti, Paulinia (BR); Marcelo Souza De Castro, Campinas (BR); Adriano Todorovic Fabro, Brasília (BR)

(73) Assignees: UNIVERSIDADE ESTADUAL DE CAMPINAS, Campinas (BR); PETRÓLEO BRASILEIRO S.A. - PETROBRAS, Rio de Janeiro (BR)

(21) Appl. No.: 18/784,617

(22) Filed: Jul. 25, 2024

(30) Foreign Application Priority Data
Sep. 26, 2023 (BR) 1020230197337

(51) Int. Cl. G01F 1/74

(52) U.S. Cl. CPC G01F 1/74

(57) ABSTRACT

The present invention refers to a measurement system comprising sensors, an electronic circuit and a demodulation method for a multiphase flow characteristics measurement system that measures multiphase flow characteristics based on electrical impedance measurements, avoiding the presence of cross-talking between the measurement points.

### CROSS-REFERENCE TO RELATED APPLICATION(S)

This application claims priority to Brazilian Patent Application No. BR1020230197337, filed Sep. 26, 2023, which is hereby incorporated herein by reference in its entirety.

### FIELD OF THE DISCLOSURE

The present invention pertains to the field of oil production systems or industry where multiphase flows are present. More specifically, the present invention relates to the measurement of characteristics of multiphase flows wherein at least one of the phases is conductive.

### BACKGROUND

There are several sensors for measuring the characteristics of multiphase flows based on electrical impedance, such as double wire and wire mesh sensors; however, these sensors do not take into account the possibility of electrical coupling between the parts of the sensors, generating parasitic impedances, and consequently the measurements differ from those expected. The phenomenon of the presence of parasitic impedances is known as cross-talking. Basically, cross-talking happens when signals from one channel interfere with signals from another adjacent channel, resulting in noise and signal distortion. This phenomenon occurs mainly in systems in which the conductors are physically close to each other, which leads to the electromagnetic coupling between the wires or tracks. When an electrical signal passes through a conductor, it generates an electromagnetic field around the same. This field can couple to adjacent conductors, causing the signal to propagate to neighboring channels.

The state of the art brings references to wire network sensors, square wave excitation and simplified demodulation, but always with the presence of cross-talking. The presence of cross-talking can result in several problems, such as: signal degradation, when the original signal can be weakened or distorted by the interference from the adjacent signal, making it difficult to correctly interpret the data; propagation delay, when the cross-talk signal can delay the propagation time of the original signal, causing synchronization problems in high-speed systems; reading errors in communication systems, especially in digital signals, in addition to the data integrity, since in data transmission networks, cross-talking can lead to packet loss or information corruption.

In this way, the problem of cross-talking can only be observed in dynamic calibration processes of the transducer element, which is not, in general, carried out in other sensors. In order to increase measurement reliability, the system of the present invention is formed by different measuring stations comprising two parallel wires. The characteristics of the flows are measured by the electrical impedance between the wires, due to the presence of liquid and gaseous phases. In the system, there is an electronic circuit that switches between the different stations, keeping only one on and turning off the others at a frequency specified by the user. However, switching causes subsequent problems in signal demodulation that cannot be performed with standard methodologies. In the system of the present invention, a new form of demodulation is proposed, in a way that avoids the presence of cross-talking and measurement errors.

In general terms, the proposed measurement system comprises sensors, electronic circuit and a demodulation method that measures characteristics of multiphase flows based on electrical impedance measurements, but without the presence of cross-talking between the measurement points, which results in less uncertainty and greater reliability in the measurements.

### STATE OF THE ART

Document US20210396700A1, titled “SYSTEM FOR MEASURING THE COMPOSITION OF A MULTI-PHASE FLOW IN A PIPE BY ANALYZING ELECTRICAL CHARACTERISTICS”, discloses a system for measuring the composition of a multiphase fluid flow in a pipeline, the multiphase flow containing a mixture of gas and liquid. The system comprises a first and a second sensor array, wherein each sensor array is adapted to measure electrical characteristics (i.e., impedance) of the flow at a predetermined rate. The system also includes an analysis unit being adapted to monitor the measured electrical characteristics of the first and second sensor arrays and to detect occurrences of periods of time involving a predetermined relation between the measured characteristics and, during such periods, assuming a liquid-rich phase and calculating the composition based on the electrical characteristics.

US20210396700A1 technology does not specify the type of sensor used, which can be capacitive, conductive or microwave-based. The US20210396700A1 technology does not consider the effect of cross-talking between subsequent sensors, which can result in inaccurate and misinterpreted readings, compromising the effectiveness and reliability of the measurements.

Document US20080270046A1, titled “PRESSURE MEASUREMENT INSTRUMENT AND METHOD”, refers to a measuring instrument having a processor, a first sensor and a second sensor. The processor is adapted to output a measurement signal incorporating a measurement of a physical quantity. The first sensor and the second sensor are connected to the processor and are operable to generate, respectively, the first and second measurements of the physical quantity. The processor defines a first measurement range within which the measurement signal depends on the first measurement and not on the second measurement. The processor defines a second measurement range within which the measurement signal depends on the second measurement and not on the first measurement. The first and second ranges meet at a predetermined transition. The first and second measurements are different in the transition, and the measurement embedded in the measurement signal crosses the transition without an abrupt change.

In US20080270046A1 technology, the processor switches the sensors, without an abrupt change, with the aim of selecting a sensor with the most appropriate precision for the condition and operation and extending the range of use of combined pressure sensors. So, in each measurement cycle, only one sensor takes the reading; in addition, no care was mentioned in choosing the switching rate. On the other hand, in the proposed invention, the four sensors are processed in the measurement cycle, switched at a high rate, 400 Hz, guaranteeing the fidelity and integrity of the input signals.

Document CN110987097A, titled “METHOD FOR MEASURING GAS-LIQUID MULTIPHASE FLOW BY USING PRESSURE FLUCTUATION”, shows a method for measuring multiphase gas-liquid flow using pressure fluctuation, belonging to the technical field of multiphase flow measurement. The method uses a vertical test tube, and 4 pressure sensors are arranged along the axial direction of the outer wall of the test tube, so that the multiphase flow is fully developed into an elastic flow pattern in the tube. When the mixed fluid passes through the tube in different component distributions, it can cause a dynamic change of pressure on the surface of the inner wall of the tube, the passage time and duration of Taylor bubbles and liquid plugs under the flow pattern of the elastic flow can be captured by monitoring the dynamic change of the pressure on the surface of the inner wall of the tube, the speed and length values of the Taylor bubbles and liquid plugs are obtained, and the multiphase flow rate is further obtained by integrating and counting the gas-liquid distribution rule of the elastic flow. The invention has the advantages of simple structure, convenient use and electromagnetic flowmeter, and can be used for online measurement of oil, gas and water flow from an oil well.

Therefore, the art lacks a system comprising a resistive sensor based on double wire, intrusive and invasive for estimating the volumetric fraction of the phases, that is, void fraction, being aimed at the electronic circuit and the demodulation method of the signal to eliminate the effect of cross-talking.

The art also lacks a system that applies switching between four sensors and captures all readings, also carrying out a measurement cycle, and each station being selected one after the other, in a way that the data captured from each measuring station is processed and combined to obtain the complete set of readings from all resistive sensors.

Additionally, in general terms, the art lacks a system for estimating the volumetric fraction of the phases using a resistive sensor based on double wire, aiming at eliminating the effect of cross-talking in the measurement, comprising a switched transmission and reception circuit and a signal demodulation method based on a gain estimator through the ratios of average power of input (carrier) and output (sensor signals).

### SUMMARY

The present invention proposes a system for measuring characteristics of multiphase flows, which comprises avoiding cross-talking, comprising: an amplification circuit connected to a receiver 2; a resistive sensor based on double wire, intrusive and invasive estimating volumetric fraction of phases, one of which being conductive in gas-liquid flows, the system further comprising an electronic excitation circuit of sensors 3, 4, 5, 6, acquisition of the signals and form of signal demodulation; measuring stations for each sensor 3, 4, 5, 6; wherein the electronic circuit comprises two multiplexer switches 9, 10 and controlled by two digital outputs D2 and D3 of a microcontroller.

Furthermore, the present invention relates to a demodulation method for a multiphase flow characteristics measurement system, as previously defined, which comprises performing the steps of: (a) performing a sequenced exchange between the sensors 3, 4, 5, 6 based on electronic circuit; (b) amplifying an output signal with the amplification circuit connected to the receiver 2 generating a single and amplified output s(t); (c) using the digital activation signals D2 and D3 to separate output signals s(t) and c(t) from each measuring station corresponding to the signals from each sensor 3, 4, 5, 6 and its respective excitation carrier wave using a binary word sequence provided by the signals D2 and D3; (d) windowing the signals s(t) and c(t) to mitigate a spectral leak, obtaining SSⱼᵢ and CCⱼᵢ and reducing a Gibbs effect; (e) estimating a gain through ratios of average power of input, CCⱼᵢ(t), and output, SSⱼᵢ(t); (f) normalizing the signals from the set of sensors 3, 4, 5, 6, in which a calibration procedure is carried out for the set of sensors R1, R2, R3 and R4 so that all stations have the same statistical properties; and (g) normalizing void fraction signals, obtaining a unit value of void fraction or liquid height with reference impedance values for a sensor 3, 4, 5, 6 completely filled with liquid and completely empty.

The present invention further discloses an electronic circuit comprising: two multiplexer switches 9, 10, a pair of electrodes 7 and an amplifier 8 addressing the switching, wherein, on the left side, there is an oscillatory input of the system, as previously defined, feeding a multiplexer switch 9, 10, connected to a transmitter wire of a sensor 3, 4, 5, 6 and, on the right side, there is another multiplexer switch 9, 10 and the amplification circuit connecting the electronic circuit to a receiver 2, both multiplexer switches 9, 10 being controlled by the digital inputs D2 and D3. The electronic circuit further comprises switching between several measuring stations of the system, as previously defined, keeping only one on and turning off the others at a frequency specified by a user. When measuring the sensors 3, 4, 5, 6, an electrical resistance of the fluid mixture that is between the transmitter 1 and the receiver 2 is measured. Furthermore, each digital output D2 and D3 is configured to send a corresponding square wave, and the combinations between them generate the binary words: 00, when both digital outputs are at a low level; 01, when the first output is at a low level and the second output at a high level; 10, when the first output is at a high level and the second output at a low level; 11, when both outputs are at high level; wherein the switching between the measuring stations is controlled by a binary word: D2=0 and D3=0, which activate the sensor 3; D2=0 and D3=1, which activate the sensor 4; D2=1 and D3=0, which activate the sensor 5; and D2=1 and D3=1, which activate the sensor 6.

### BRIEF DESCRIPTION OF THE DRAWINGS

In the state of the art, there are measurement system solutions that estimate the phase compositions in a multiphase flow. The advantage of the system of the present invention is that it is formed by different measuring stations comprising two parallel wires, the characteristics of the flows are measured by the electrical impedance between the wires due to the presence of liquid and gaseous phases, comprising a different form of demodulation for avoid the presence of cross-talking and errors in measurements. Therefore, the present invention will be described below with reference to typical embodiments thereof and also with reference to the attached drawings, in which:

FIG. 1 is an alternative representation of physical sensors based on double wire of the system of the invention comprising a first sensor 3, a second sensor 4, a third sensor 5 and a fourth sensor 6, wherein the electrical impedance of the fluid mixture that is between the transmitter 1 and receiver 2 is measured, according to a preferred embodiment of the present invention.

FIG. 2 is a representation of (a) a set of resistive sensors 3, 4, 5, 6 with conductive fluid as medium and parasitic impedances between sensors, (b) electrical impedance between transmitter 1/receiver 2 pair and (c) indicating the presence of a parasitic impedance between sensors 3, 4, 5, 6, according to a preferred embodiment of the present invention.

FIG. 3 is a representation of an electronic circuit comprising a pair of electrodes 7 and an amplifier 8, for the switching approach, wherein, on the left side, there is the oscillatory input of the system feeding a multiplexer switch, connected to the wire transmitter of the sensor, and, on the right side, there is another multiplexer switch and the amplification circuit connecting the circuit to the receiver, both multiplexer switches 9, 10 being controlled by the digital inputs D2 and D3, according to a preferred embodiment of the present invention.

FIG. 4 is a simplified representation of the demodulation steps of the sensor output signals s(t) using the switching approach, wherein i represents the sensors 3, 4, 5 and 6 and j the switching cycle: (a) the output signals of each sensor Sᵢ^{j} of its respective carrier wave Cᵢ^{j} are recovered using the binary word of the digital signals D1 and D2; (b) windowing is performed on the separate signals, with a window Wⱼ; and in (c) the gain is estimated through the ratios between the average powers of the windowed input and output signals; (d) the phase difference is estimated through the delay time between the output of each sensor Sᵢ^{j} of its respective carrier wave Cᵢ^{j}, obtained through the peak of the cross-correlation between these two signals; and, finally (e), the optimization of the calibration parameters of the sensor set is carried out, in accordance with a preferred embodiment of the present invention.

FIG. 5A is a representation of the response of resistive sensors using the non-switching configuration in terms of void fraction α.

FIG. 5B is a representation of a highlight in a measurement showing the effect of cross-talking.

FIG. 6A is a representation of the response of resistive sensors using the switching configuration in terms of void fraction α, according to a preferred embodiment of the present invention.

FIG. 6B is a representation of a highlight on a unit cell showing the effect of cross-talking, according to a preferred embodiment of the present invention.

### DETAILED DESCRIPTION

Specific embodiments of the present disclosure are described below. In an effort to provide a concise description of these embodiments, all features of an actual implementation may not be described in the specification. It should be appreciated that, in the development of any actual implementation, as in any engineering or design project, numerous implementation-specific decisions must be made to achieve the specific objectives of the developers, such as compliance with the interconnection of the elements of the multiphase flow characteristics measurement system to avoid cross-talking, which may vary from one implementation to another. In addition, it should be appreciated that such a development effort may be complex and time-consuming, but would nevertheless a be routine design, engineering and manufacturing undertaking for those of ordinary skill having the benefit of this disclosure.

The present invention is related to a system for measuring characteristics of multiphase flows to avoid cross-talking comprising a set of resistive sensors based on double wire, intrusive and invasive for estimating the volumetric fraction of the phases, one being conductive, in gas-liquid flows. It further comprises an excitation and acquisition electronic circuit for the switched sensors 3, 4, 5, 6 that solves the problem of cross-talking between the sensors. Furthermore, the present invention comprises a demodulation method from switched signals to obtain void fraction measurements.

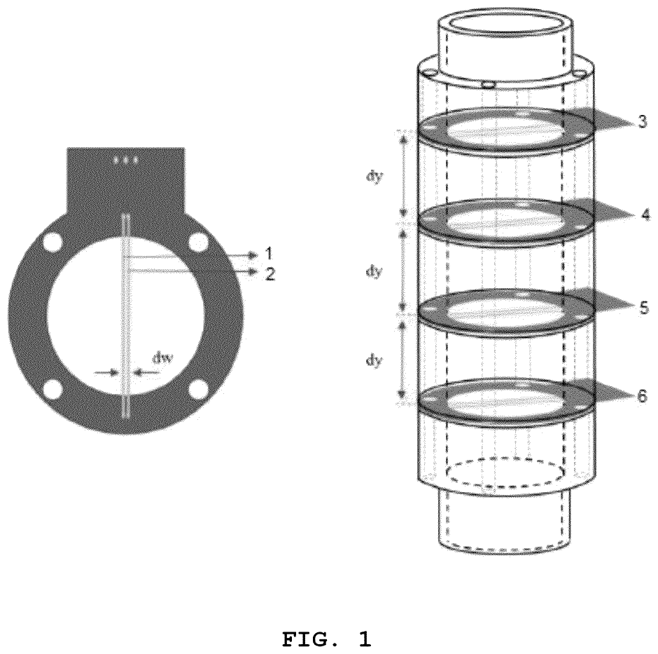

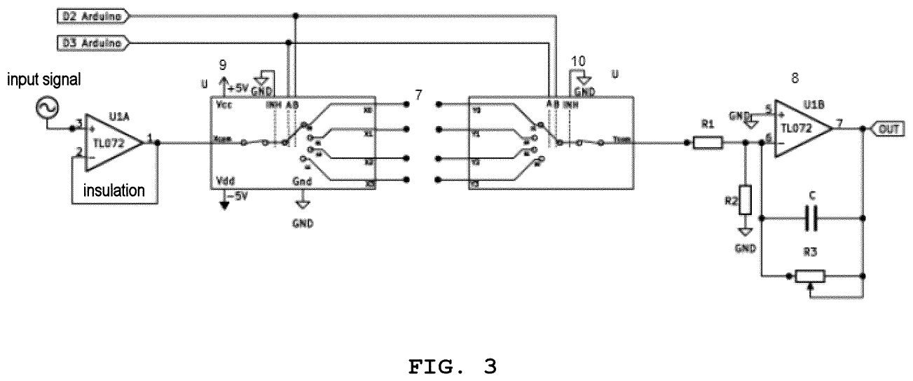

Firstly, the modulation of fluid conductivity signals is carried out through the electronic circuit as seen in FIG. 3, in which physical sensors based on double wire are used, as seen in FIG. 1. Therefore, the proposed electrical circuit can be used with other sensors that have the same measurement principle (Shi et al., Conductance sensors for multiphase flow measurement: A review, IEEE Sensors Journal 2021). In the measurement principle of the sensors, the electrical conductance of the fluid mixture between the transmitter and receiver is measured.

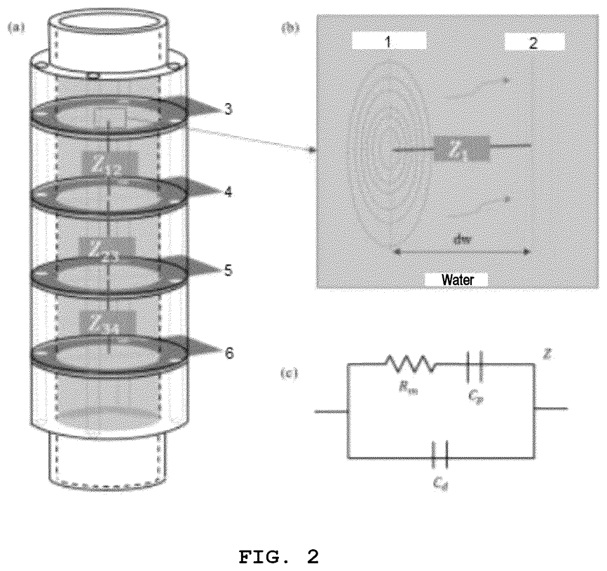

The presence of the conductive fluid, as seen in FIG. 2, causes parasitic impedances to appear between the sensors, which generate problems in measurements. Such problems are only observed in dynamic calibrations, not observable in measurements in flow situations, thus masking the problem. Accordingly, to solve the cross-talking effect, a sequenced exchange is carried out between the sensors 3, 4, 5, 6 based on electronic circuits.

Still in step (a), for the selection of the transmitter 1 and receiver 2 from the set of four sensors 3, 4, 5, 6 through two multiplexers 9, 10, as seen in the FIG. 3, an electrical circuit is proposed (each pair of wires is a sensor) for direct measurement of the impedance of the four sensors 3, 4, 5, 6 based on the switching between the sensors 3, 4, 5, 6. For this, two multiplexers (CD 4052) are used to select the transmitter 1 and receiver 2 from the set of four sensors 3, 4, 5, 6, so that only one transmitter 1/receiver 2 pair (a sensor) is activated at each moment. This prevents two sensors from being connected at the same time, and consequently avoids the problem of cross-talking. In this case, the control of the multiplexers 9, 10 is done by a binary word represented in two digital signals D2 and D3 coming from an Arduino (ATmega328 microcontroller).

Still in step (a), the switching frequency f_{CH} must be lower than the carrier wave frequency f_{C}, and the acquisition frequency f_{S} must follow the Nyquist theorem, that is, the acquisition frequency must be at least twice the maximum frequency present in the signal, in this case, the frequency of the carrier wave fc. It is interesting that the frequencies f_{CH} and f_{C} are integer multiples; therefore, each cycle allocates an integer number of periods of the carrier wave, reducing the effects of spectral leakage of the signal.

Still in step (a), the activation of the sensors 3, 4, 5, 6 is done by the binary word of the digital signals D2 and D3. Thus, D2=0 and D3=0 activate sensor 3; D2=0 and D3=1 activate sensor 4; D2=1 and D3=0 activate sensor 5; and finally, D2=1 and D3=1 activate sensor 6. Both digital signals D2 and D3 control the multiplexers 9, 10.

In step (b), amplifying of the output signal with an amplification circuit connected to the receiver 2 generates the single and amplified output s(t). An operational amplifier at the output acts as a current-to-voltage converter, where the output voltage is linearly proportional to the liquid height in the measured two-phase flow, and the circuit gain is given in terms of (Shi et al., Conductance sensors for multiphase flow measurement: A review, IEEE Sensors Journal 21 12913-129252021), as observed in equation (1) below:

$$\vert {V}_{o} \vert = ( \frac{1}{{G}_{f}} ) {G}_{m} \vert {V}_{i} \vert , \qquad ( 1 )$$

Where:
Vₒ and Vᵢ are the output and input voltages,
G_{f} is the reference conductance, and
Gₘ is the conductance of the two-phase flow being measured.

So, the conductance of the two-phase flow being measured (Gₘ) requires demodulation to be measured over time.

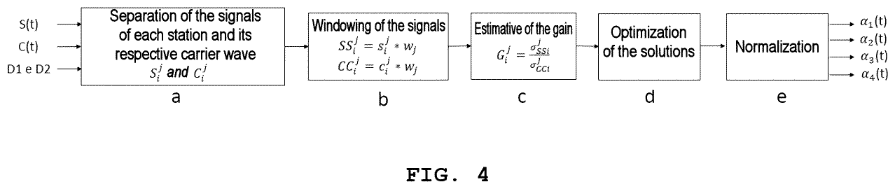

The following steps comprise demodulating the signals to obtain the phase fractions, which is shown in FIG. 4. In step (c), the digital activation signals D2 and D3 are used to separate the signals s(t) and c(t) corresponding, respectively, to the output of each measuring station corresponding to the signals from each sensor 3, 4, 5, 6 and their respective excitation carrier wave using a binary word sequence provided by the signals D2 and D3. For each switching cycle j, a time series with an integer number of periods of the carrier wave c(t) is available from each sensor i.

In step (d), the s(t) and c(t) signals are windowed to mitigate spectral leakage, improving the quality of the signals, reducing unwanted effects and making the results more accurate. The window w is multiplied for each switching segment j for each sensor i to obtain the windowed signal SSⱼᵢ and CCⱼᵢ, thus obtaining SSⱼᵢ and CCⱼᵢ and reducing the Gibbs effect.

In step (e), the response of each sensor can then be characterized as a transfer function at the carrier frequency. A gain estimator is used to estimate the ratios of average power of input (carrier) CCⱼᵢ(t) and output (sensor signals) SSⱼᵢ(t). The gain estimate is related to the fraction of the phases (Eq. 1).

Still in step (e), the phase difference can be estimated; the phase difference can also be calculated by this approach, but using the cross-correlation time delay between CCⱼᵢ(t) and SSⱼᵢ(t). The resulting time series has sampling frequency f_{CH}.

In step (f), there is the normalization of signals from the set of sensors 3, 4, 5, 6, in which a calibration procedure is carried out for the set of sensors R1, R2, R3 and R4, so that all stations have the same statistical properties.

In step (g), the normalization of the signals in terms of void fractions (one of the key parameters in predicting the occurrence of instabilities in two-phase flow) comprises obtaining the unit value of void fraction or liquid height with the reference impedance values for the sensor completely filled with liquid and completely empty (Santos et al. Sensing platform for two-phase flow studies, IEEE Access 7 5374-5382, 2019).

### Example of Embodiment/Tests/Results

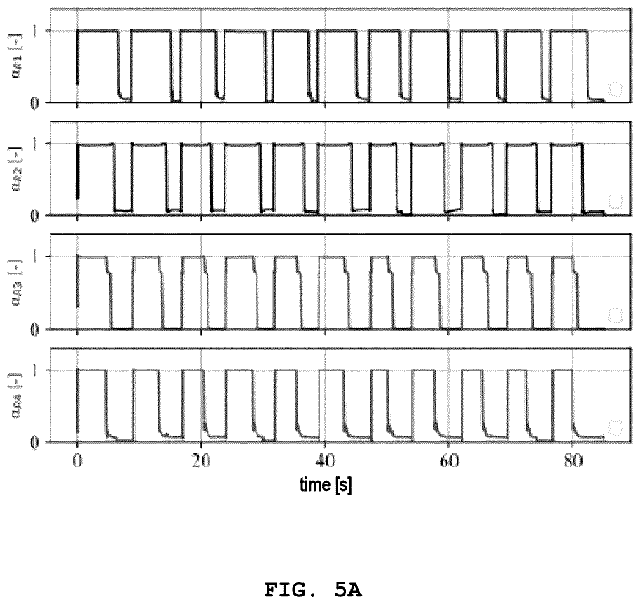

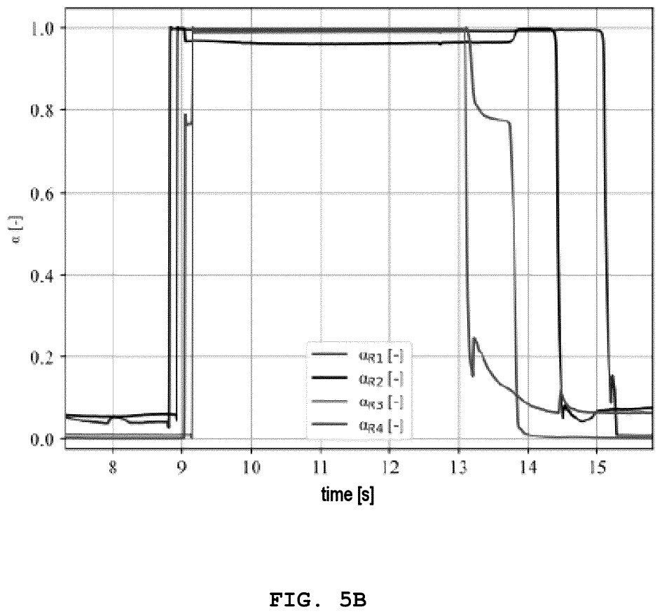

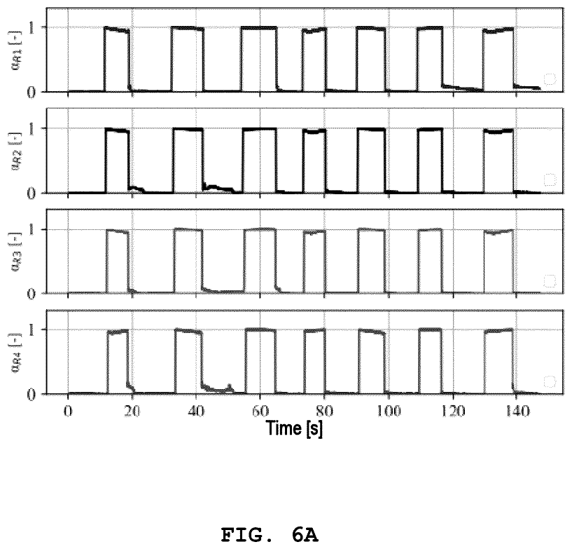

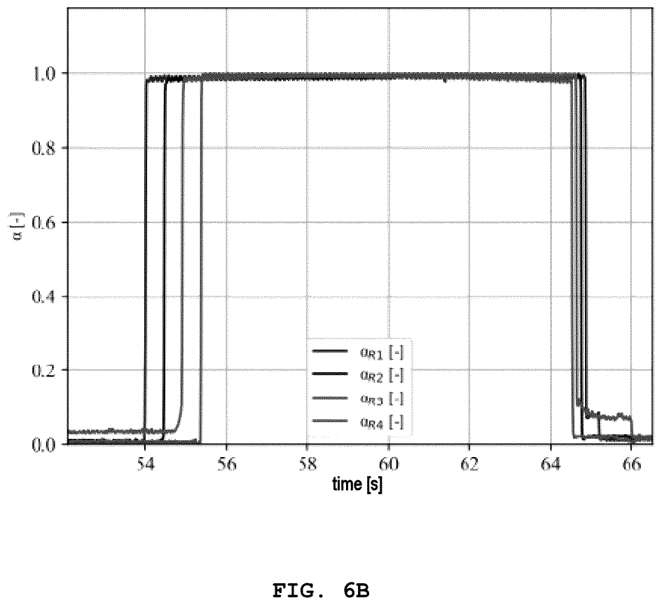

An example of a signal obtained from sensors 3, 4, 5, 6, by the switching methodology used in the present invention, is presented in FIG. 6A, where, in the detail of FIG. 6B, there is no presence of cross-talking, resolved by the method of the present invention. FIGS. 5A and 5B present the same type of measurement, but now obtained with the traditional non-switched method, wherein the presence of cross-talking is evident in the abrupt changes in amplitude in the response of the sensors when the double wire (1, 2) of one or more pairs of sensors is simultaneously wetted by the conductive wire, creating a parasitic impedance situation.

That said, as can be seen, FIGS. 5A, 5B, 6A and 6B are all from a dynamic calibration experiment of the sensor, wherein the entire resistive sensor set is kept vertical, that is, the fraction of void is unitary, sometimes equal to 1 (completely filled with water) and sometimes equal to 0 (totally empty). In this experiment, the presence of the cross-talking effect is clearly observed, shown in FIGS. 5A and 5B. In FIGS. 6A and 6B, the signals are observed, without the presence of cross-talking, thus proving the efficiency of the switching and demodulation methodology of the present invention.

1. A multiphase flow characteristics measurement system comprising:
an amplification circuit connected to a receiver;
a resistive sensor based on double wire, intrusive and invasive, estimating volumetric fraction of phases, one of which being conductive in gas-liquid flows;
the multiphase flow characteristics measurement system further comprises an excitation electronic circuit of sensors 3, 4, 5, 6, acquisition of the signals and form of signal demodulation; and
measuring stations for each sensor 3, 4, 5, 6;
wherein the electronic circuit comprises two multiplexer switches and controlled by two digital outputs D2 and D3 of a microcontroller.

2. A demodulation method for the multiphase flow characteristics measurement system of claim 1, the method comprising:
performing a sequenced exchange between the sensors 3, 4, 5, 6 based on the electronic circuit;
amplifying an output signal with the amplification circuit connected to the receiver generating a single and amplified output s(t);
using the digital activation signals D2 and D3 to separate output signals s(t) and c(t) from each measuring station corresponding to the signals from each sensor 3, 4, 5, 6 and its respective excitation carrier wave using a binary word sequence provided by the signals D2 and D3;
windowing the signals s(t) and c(t) to mitigate a spectral leak, obtaining SSⱼᵢ and CCⱼᵢ and reducing a Gibbs effect;
estimating a gain through ratios of average power of input, CCⱼᵢ(t), and output, SSⱼᵢ(t);
normalizing the signals from the set of sensors 3, 4, 5, 6, in which a calibration procedure is carried out for the set of sensors R1, R2, R3 and R4 so that all stations have the same statistical properties; and
normalizing void fraction signals, obtaining a unit value of void fraction or liquid height with reference impedance values for a sensor 3, 4, 5, 6 completely filled with liquid and completely empty.

3. An electronic circuit comprising:
two multiplexer switches; and
a pair of electrodes and an amplifier addressing the switching, wherein, on the left side, there is an oscillatory input of the multiphase flow characteristics measurement system of claim 1 feeding a multiplexer switch, connected to a transmitter wire of a sensor 3, 4, 5, 6 and, on the right side, there is another multiplexer switch and the amplification circuit connecting the electronic circuit to a receiver, both multiplexer switches being controlled by the digital inputs D2 and D3.

4. The electronic circuit of claim 3, wherein the electronic circuit switches between several measuring stations of the multiphase flow characteristics measurement system, keeping only one on and turning off the others at a frequency specified by a user.

5. The electronic circuit of claim 3, wherein, when measuring the sensors 3, 4, 5, 6, an electrical resistance of the fluid mixture that is between the transmitter and the receiver is measured.

6. The electronic circuit of claim 3, wherein each digital output D2 and D3 is configured to send a corresponding square wave, and wherein the combinations between the corresponding square waves generate binary words:
00, when both digital outputs are at a low level;
01, when the first output is at a low level and the second output at a high level;
10, when the first output is at a high level and the second output at a low level; and
11, when both outputs are at high level;
wherein the switching between measuring stations is controlled by a binary word:
D2=0 and D3=0, which activate the sensor 3;
D2=0 and D3=1, which activate the sensor 4;
D2=1 and D3=0, which activate the sensor 5; and
D2=1 and D3=1, which activate the sensor 6.
